(19) United States
(12) Patent Application Publication
(10) Pub. No.: US 2003/0217706 A1
(43) Pub. Date: Nov. 27, 2003

(54) Air port and smelt spout cleaner and drop jaw tip

(76) Inventors: Kenneth A. Pingel, Hillsboro, OR (US); Michael deSousa, Portland, OR (US)

Correspondence Address: DELLETT AND WALTERS, 310 S.W. FOURTH AVENUE, SUITE 1101, PORTLAND, OR, 97204, US

(21) Appl. No.: 10/435,437

(22) Filed: May 9, 2003

Related U.S. Application Data
(60) Provisional application No. 60/379,538, filed on May 9, 2002.

(51) Int. Cl. F16L 55/00

(52) U.S. Cl. 122/387; 15/104.16; 15/104.05; 122/379

(57) ABSTRACT

An air port or smelt spout cleaning tip presents a wider cleaning area configuration on an insertion phase, and on retraction, the tip collapses to provide a smaller size to prevent against hanging up on adjacent structures.

### BACKGROUND OF THE INVENTION

This invention relates to cleaning of air ports and smelt spouts in recovery boilers.

In operation of recovery boilers, it is necessary to clean the air ports of build up material that collects and, over time, obstructs the air ports. One style of known port cleaner employs a “cookie cutter” type operation, wherein a fixed size and shape punch is periodically moved into the air port in an attempt to break away any built up material. This type device travels through a single fixed actuation path.

However, over time, bushings will wear, which alters the exact operation path through which the punch will move. This can result in the punch getting caught on the port, for example,

An example of a prior art device is illustrated schematically in FIG. 1 and FIG. 2. In FIG. 1, which is a top sectional view of an installation of the prior art device, a wind box 10 is provided on the outside wall of the recover boiler tubes 12. Several air ports 14 enable entry of combustion air 16 (which is supplied to the wind box by means not shown) into the boiler interior. The prior art device employs a ring-shaped gap area 18 around the air ports, which are able receive hollow sleeves 20 therein. The sleeves are mounted to a compression air cylinder 22, which is actuable to cause the sleeves to translate into and out of the air ports on an insertion stroke. The sleeves are in the retracted state in FIG. 1 and are in the inserted state in FIG. 2. The hollow sleeve allows entry of air therethrough into the air port.

The tip portion of the sleeve comprises a horn that enters into the airport is shaped similar to the shape of the airport opening, but is slightly smaller. The outside perimeter of the horn acts to clean the air port by entry into the air port, and thereby scraping or knocking off built up material. An attempt to provide damping (i.e. some air flow control) is made by throttling the horn within the volute of the air port. However, the hollow nature of the sleeve and horn opening allows little actual flow control, as airflow will go around the opening between the sleeve and airport and through the hollow tube portion.

### SUMMARY OF THE INVENTION

In accordance with the invention, an improved cleaning tip is provided that has a larger cleaning area on the penetrating or insertion stroke, but is of smaller area on the removal or retraction stroke. Further, a system for enhancing operation of prior art type cleaning devices is provided.

Accordingly, it is an object of the present invention to provide an improved cleaning tip for an air port cleaner.

It is a further object of the present invention to provide an improved cleaning tip that provides a larger cleaning area on insertion and a reduced area on retraction.

It is yet another object of the present invention to provide an improved system for cleaning air ports that is adapted for retrofitting to prior art type cleaning actuators.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is an example of a prior art device in the retracted stage illustrated schematically;

FIG. 2 is an example of a prior art device in the inserted stage illustrated schematically;

FIG. 3 is a side view of the drop jaw tip according to the present invention during a penetrating stroke;

FIG. 4 is a side view of the drop jaw tip according to the present invention during a removal stroke;

FIGS. 5, 5A comprise a cross sectional partially transparent view of a typical installation of the tip of FIGS. 3 and 4, 5A being detail of the tip;

FIG. 6 is a side view of a damper assembly adapted for retrofitting the prior art with a damper and drop jaw tip cleaning device according to the invention;

FIGS. 7, 7A comprise a side view of an intermediate point in the installation of the device, 7A being an enlarged view of the cam follower; and

FIG. 8 is a view of the finally installed damper assembly and drop jaw tip as attached to a cleaning actuator of the prior art.

### DETAILED DESCRIPTION

The system according to a preferred embodiment of the present invention comprises and air port cleaning system employing a drop tip jaw. On the inward portion of the cleaning stoke, where the cleaning tip is inserted into the air port, the tip expands to a wider configuration. On retraction, the tip collapses to provide a smaller size.

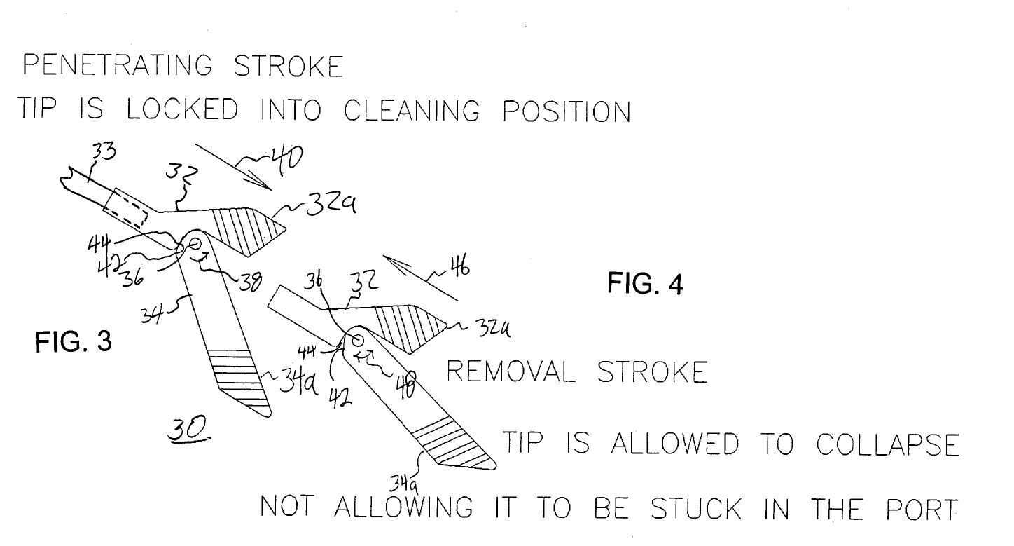

Referring to FIG. 3, a side view of the drop jaw tip according to the present invention during a penetrating stroke, the cleaning tip 30 comprises a base portion 32, which is adapted to mount to a support rod 33 device. The base portion includes a forward cleaning tip 32a which may have slots or serrations defined thereon. Pivotally mounted to base portion 32 at pivot point 36 is a movable cleaning tip portion 34, which is adapted to rotate forwardly as indicated by arrow 38. The portion 34a of the tip distal from pivot point 36 can include slots or serrations thereon.

In operation, the tip on a penetrating stroke is inserted to the air port, in the direction of arrow 40. The upper and lower portions 32a and 34a act to clean the air port. The swinging portion 34 includes an engaging portion 42 that seats against a corresponding portion 44 on the base 32, which locks the portion 34 against further rearward movement.

Referring now to FIG. 4, a side view of the drop jaw tip according to the present invention during a removal stroke, it may be observed that the removal in the direction of arrow 46 results in the tip portion 34 being able to move forwardly (or backwardly) about the pivot 36 as indicated by arrow 48. Thus, the tip “collapses” and is unlikely to become stuck in the air port.

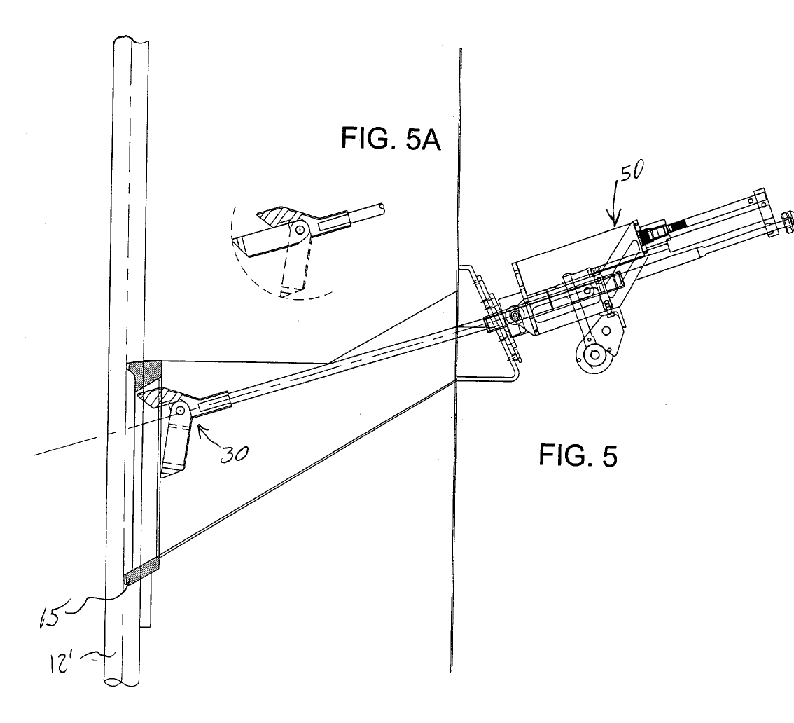

FIG. 5 is a cross sectional partially transparent view of a typical installation of the tip of FIGS. 3 and 4. The recovery boiler wall 12′ has an air port defined therein, which may include an airport casting 15 to further define the opening and to protect the tube wall from damage. A suitable airport casting is such as shown in U.S. Pat. No. 6,055,943, for example, the disclosure of which is incorporated herein by reference.

The drop jaw tip 30 is mounted to the end of an air port cleaner device which may comprise, for example, a device as described in U.S. Pat. No. 5,351,631, the disclosure of which is incorporated herein by reference. To clean the port, the cleaner device will extend the tip into and out of the air port, suitably indexing or otherwise moving around to ensure that the entire opening of the air port is cleaned. FIG. 5A shows in phantom the range of movement of the tip.

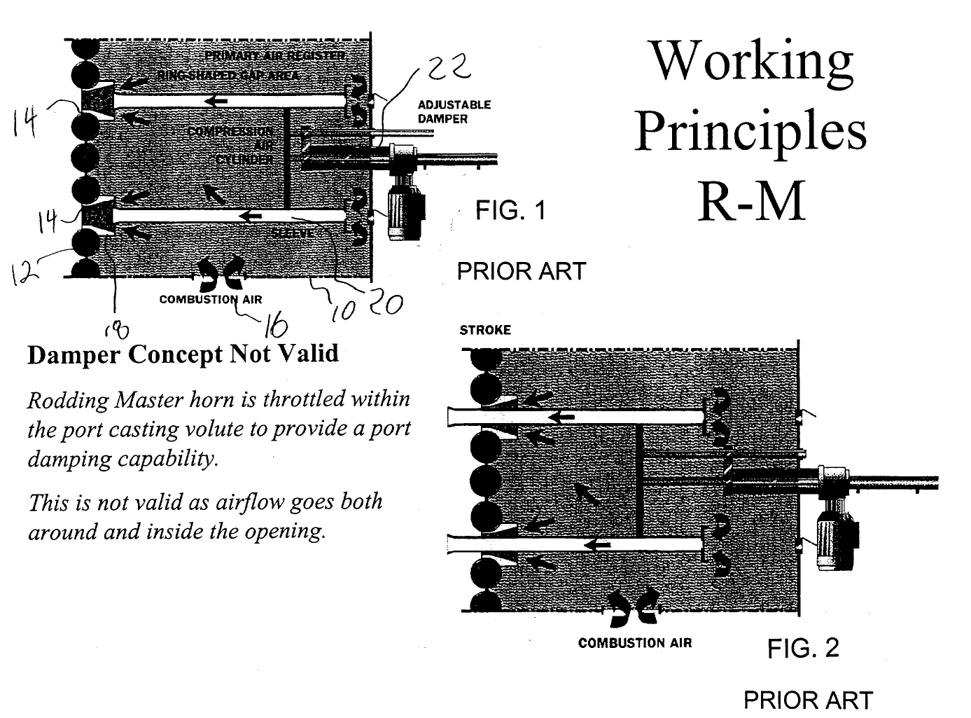

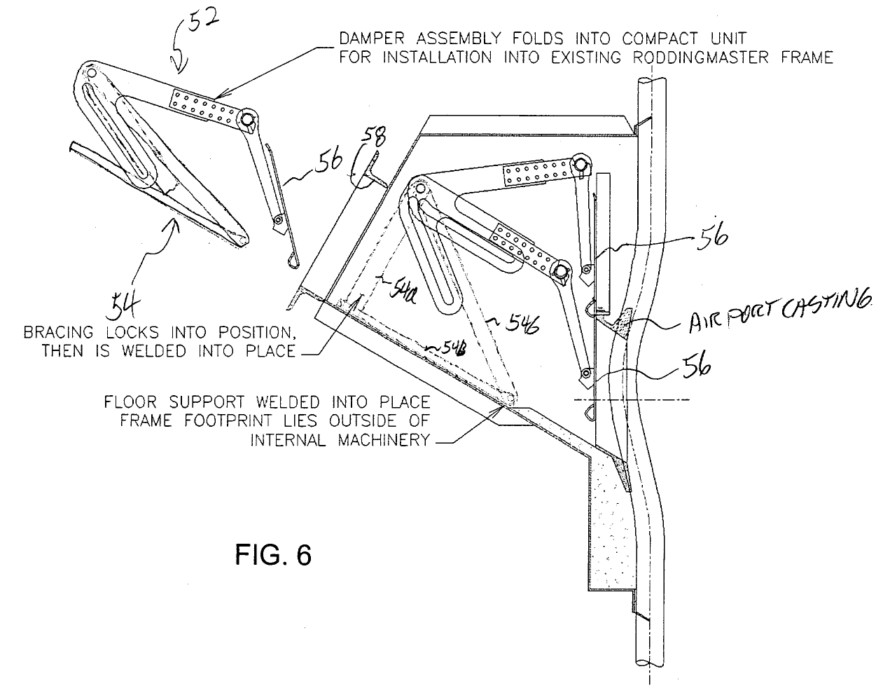

Referring now to FIG. 6, a side view of a damper assembly adapted for retrofitting the prior art with a damper and drop jaw tip cleaning device according to the invention, a system for converting a prior art style air port cleaner as in FIG. 1, and FIG. 2 is shown. The particular device illustrated as being converted is a type of device sold by Kvaerner of Sweden under the trade name Roddingmaster. In FIG. 6, the driving system and controls have been removed in preparation for the retrofitting. Also, the sleeve tube and horn of FIG. 1 are removed and discarded. A folding damper assembly 52 includes foldable brace members 54 and a damper assembly 56 mounted thereto. These components are shown in the folded configuration at the left of FIG. 6. In the folded state, these components can be inserted into the opening 58 in the existing framework which supported the removed components. Once inside the frame, the damper assembly is unfolded, and frame brace members 54 (comprising vertical member 54a, horizontal member 54b and diagonal member 54c) lock into place and the bottom portion 54b is welded (for example) into place. The pivoting interconnection of the components thus provide the ability for the damper 56 to move between the upper open position and the lower closed position (both positions are illustrated in FIG. 6.). It will be observed that the damper assembly includes an elongate cam slot 60 therein that angles upwardly slightly at a rearward portion thereof.

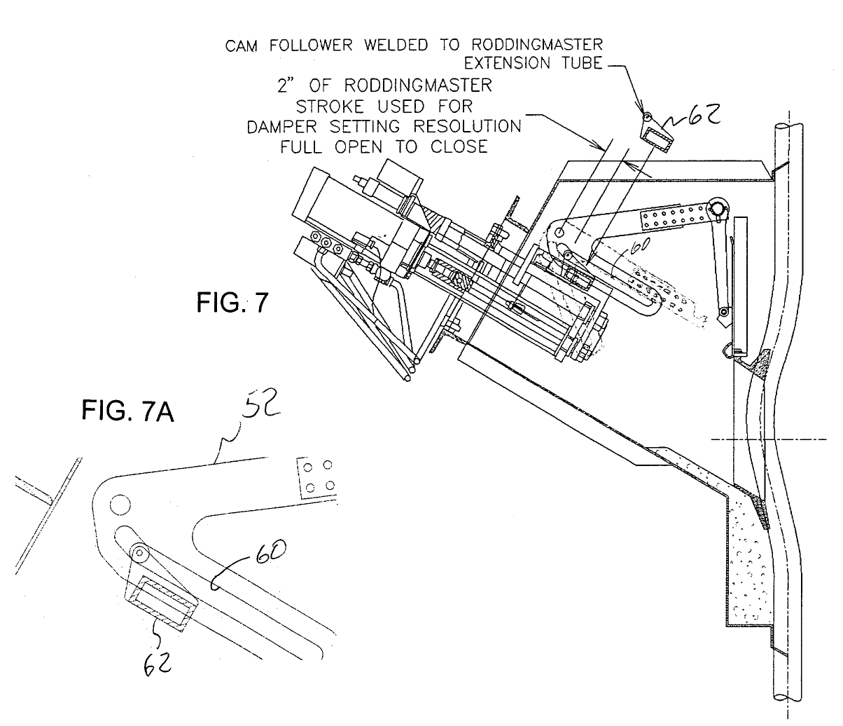

Referring now to FIG. 7, which illustrates an intermediate configuration during the installation of the device according to the invention, a cam follower 62 is mounted to the extension tube portion of the Roddingmaster actuation device (which is shown remounted to its support frame). The cam follower engages the cam slot, whereupon movement of the extension tube portion of the Roddingmaster device causes the damper assembly to open and close, thereby enabling adjustment of the amount that the air port is opened. The angled configuration of the cam slot rear portion allows the damper to open or close to a desired degree by controlling the amount of extension of the extension tube. An exemplary amount of extension provided by the extension tube is 12 inches, and, given the configuration of the cam slot, suitably, 2 inches of the extension stroke provides control of the damper anywhere between fully closed or fully open. The remaining 10 inches of extension leave the damper in the fully open position, and are then used to operate the cleaning device as discussed hereinbelow. FIG. 7A shows an enlarged view of the cam follower 62 and its interaction with the cam slot 60.

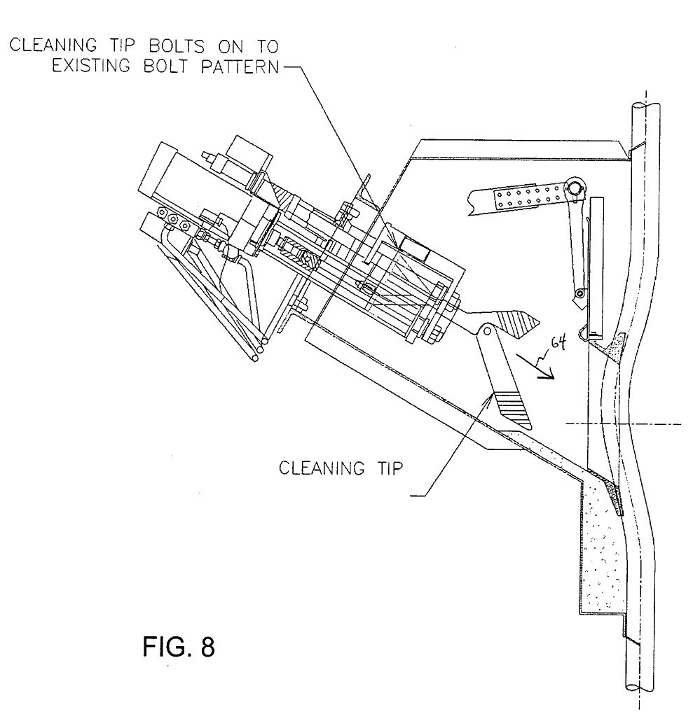

FIG. 8 is a view of the installed damper assembly and drop jaw tip as attached to a cleaning actuator of the prior art. A portion of the arm 52 is removed in this view for clarity. A drop jaw tip cleaner as described in connection with FIGS. 3 and 4 is suitably mounted to the extension tube of the Roddingmaster device, being boltable via the existing bolt pattern on the device.

Now, in operation, the extension tube of the Roddingmaster device is set somewhere within the last 2 inches of its outward stroke, so that the damper blade is set to the desired degree of closing. When a cleaning cycle is to be performed, the extension tube is caused to extend (in the direction of arrow 64). In the first 2 inches of extension, the cam follower will ride in the cam slot, causing the damper blade to retract to the fully open position (which is the position illustrated in FIG. 8). The remaining extension of the extension tube will drive the cleaning tip into the air port opening, which will result in cleaning of the air port. Then, on retraction of the extension tube, the drop jaw tip will collapse as in FIG. 4, enabling removal of the cleaning tip without it getting caught on the air port. The extension tube is then retracted to the desired position to result in the damper blade moving down to the position preferred by the operation of the boiler.

Other variations over the embodiment that has been described are also possible. For example, while the tip is illustrated as using a substantially vertical movement, horizontal or diagonal moving components can be used. Two or more movable portions can be used instead of the single hinged moving component of the tip.

Therefore, in accordance with the invention, and improved ability to control the air port air is provided while providing an improved cleaning tip to clean the air port. The cleaning tip may suitably be retrofitted to an existing air port cleaning device such as a Roddingmaster brand device, or may suitably be employed with an air port cleaning device manufactured by Anthony-Ross Company, or the like. The cleaning tip is advantageous in that on the insertion stroke it presents a larger area of cleaning action, but on the withdrawal stroke, it is collapsible to a small area to minimize the risk of getting hung up on the air port or air port casting.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A cleaning tip for cleaning air ports, smelt spouts, or the like, comprising:
a member that presents a larger overall cleaning area on an insertion stroke and a smaller overall area on a withdrawal stroke.

2. The cleaning tip according to claim 1, wherein the member comprises a drop tip.

3. The cleaning tip according to claim 1, wherein the member expands and contracts area in a relatively vertical direction.

4. The cleaning tip according to claim 1, wherein the member expands and contracts area in a relatively horizontal direction.

5. The cleaning tip according to claim 1, wherein the member expands and contracts area in a relatively horizontal direction and in a relatively vertical direction.

6. The cleaning tip according to claim 1, wherein the member expands and contracts area in a direction that is neither substantially relatively horizontal nor relatively vertical.

7. The cleaning tip according to claim 1, wherein said member includes a fixed portion and at least one movable portion.

8. The cleaning tip according to claim 1, wherein said member includes a fixed portion and plural movable portions.

9. The cleaning tip according to claim 8, wherein said at least one movable portion is hingedly cooperative with said fixed portion, to move between a wider configuration and a narrower configuration.

10. A device for cleaning a part of a recovery boiler, comprising:
an actuating device for inserting and removing a cleaning tip to the part being cleaned, wherein said cleaning tip comprises:
a member that presents a larger overall cleaning area on an insertion stroke and a smaller overall area on a withdrawal stroke

11. The device according to claim 10, wherein the member comprises a drop tip.

12. The device according to claim 10, wherein the member expands and contracts area in a relatively vertical direction.

13. The device according to claim 10, wherein the member expands and contracts area in a relatively horizontal direction.

14. The device according to claim 10, wherein the member expands and contracts area in a relatively horizontal direction and in a relatively vertical direction.

15. The device according to claim 10, wherein the member expands and contracts area in a direction that is neither substantially relatively horizontal nor relatively vertical.

16. The device according to claim 10, wherein said member includes a fixed portion and a movable portion.

17. The device according to claim 10, wherein said member includes a fixed portion and plural movable portions.

18. The device according to claim 16, wherein said movable portion is hingedly cooperative with said fixed portion, to move between a wider configuration and a narrower configuration.

19. The device according to claim 10, wherein said recovery boiler includes an air port, further comprising a damper member for providing selectable damping of the air port.

20. The device according to claim 19, further comprising an engagement member for operatively connecting said damper member with said actuating device, whereby said damper is controlled by operation of said actuating device.

21. A method for converting an air port cleaner device having an extensible sleeve cleaning member, comprising the steps of:
removing the sleeve cleaning member; and
installing a cleaning member that presents a larger overall cleaning area on an insertion stroke and a smaller overall area on a withdrawal stroke in place thereof.

22. The method according to claim 21, further comprising the step of installing an air port casting on the air port.

23. The method according to claim 21, further comprising the step of installing an air port damper mechanism.

24. The method according to claim 23, wherein said step of installing an air port damper mechanism comprises installing the damper mechanism such that a first portion of an extension stroke of a cleaning actuator is adapted to control the extent to which the damper mechanism covers the air port.

25. The method according to claim 24, wherein said damper mechanism is operatively engaged with said actuator via a cam follower mechanism.
